(19) United States
(12) Patent Application Publication
(10) Pub. No.: US 2013/0240329 A1
(43) Pub. Date: Sep. 19, 2013

(54) Conveyor Device For Conveyance Of Workpieces

(71) Applicant: SCHULER PRESSEN GMBH, Goppingen (DE)

(72) Inventor: Carsten Brechling, Ulm (DE)

(21) Appl. No.: 13/889,663

(22) Filed: May 8, 2013

(30) Foreign Application Priority Data
Nov. 9, 2010 (DE) 10 2010 060 452.6

(51) Int. Cl. B65G 33/04; B65G 33/06

(52) U.S. Cl. CPC B65G 33/04; B65G 33/06
USPC 198/676

(57) ABSTRACT

This conveyor device is for the conveyance of blanks (14). Preferably the device has a drivable conveyor spindle (11), which has a spiral-like conveyor groove (20) on its exterior, has a guide element (28), which is arranged separated from the longitudinal axis (12) of the conveyor or spindle (11) and extends along the conveyor spindle (11), wherein the inclination (α) of the conveyor groove (20) changes in the conveying direction (R) of the conveyor spindle (11).

### CROSS REFERENCE TO RELATED APPLICATION

The present application is based upon and claims the benefit of PCT/EP2011/068764, filed 26 Oct. 2011; which is based on German patent application no. 10 2010 060 425.6, filed 9 Nov. 2010.

### FIELD OF THE INVENTION

The invention relates to a conveyor device for conveyance of blanks to a shaping machine.

### BACKGROUND OF THE INVENTION

The invention relates to a conveyor device for conveyance of blanks and especially of bowls or cups to a shaping machine, such as a press. These bowls or cups have a pot-like shape with an essentially cylinder-shaped surface area and a base. In the shaping machine, the bowl is first held with the aid of a blank holder that engages the bowl. With the aid of a coaxial drawing punch that moves through inside the blank holder, the bowl is then shaped into a can body consisting of a can bottom and a can wall joined to the can bottom without joints. The applicant knows of such a shaping machine, for example, from German Patent Application 10 2010 019 323.2-14.

Known conveyor devices for shaping machines for example have a rotary table which have a plurality of recesses distributed across their circumference, each recess being able to engage a pot-like blank. By rotating this rotary table in steps, it is always possible to move one of the blanks into the desired working position in the shaping machine.

### SUMMARY OF THE INVENTION

The blanks must be fed to the shaping machine. To this end, it is important that the conveyor device delivers the blanks or workpieces with adequate speed and high precision into a position in which the blank holder and drawing punch of the shaping machine or press can engage the bowl exactly. The shaping machine operates at stroke rates of approximately 400 to 500 strokes per minute. At such stroke rates, the conveyor device must convey a blank into position underneath the blank holder or underneath the drawing punch approximately every 120 to 150 milliseconds. In addition, the very thin-walled blank may not be damaged. If the wall of the blank is bent, this could otherwise cause the blank holder to no longer engage the blank but to instead mount onto the top edge of the wall and destroy the blank instead of clamping it into the desired position for the drawing punch.

Proceeding from the above, the present invention creates a conveyor device which guarantees a sufficiently high conveying capacity, ensures exact positioning of the blanks to be transported and prevents damage to the blank.

The conveyor device has the following characteristics. The conveyor device for conveyance of blanks (14), preferably has a drivable conveyor spindle (11), which has a spiral-like conveyor groove (20) on its exterior, has a guide element (28), which is arranged separated from the longitudinal axis (12) of the conveyor spindle (11) and extends along the conveyor spindle (11), wherein the inclination (α) of the conveyor groove (20) changes in the conveying direction (R) of the conveyor system (11).

The conveyor device has a drivable conveyor spindle, which is preferably operated at constant rotational speed. On its exterior, a spiral-like conveyor groove is provided in the conveyor spindle. In addition, a guide element, which extends along the conveyor spindle in the conveying direction, is arranged separated from the exterior of the conveyor spindle and thus separated from the conveyor groove. When the conveyor spindle rotates, the blanks arrive between the guide element and the spiral-like conveyor groove. The rotation moves them in the conveying direction between the conveyor spindle and the guide element in the conveying direction until they reach their end position, wherein the blanks rest against both the conveyor groove on the conveyor spindle and also against the guide element.

According to the invention, the course of the conveyor groove is chosen so that its inclination or pitch changes in the conveying direction. The conveying speed and clearance between two blanks along the conveyor path can be varied in this manner. This can ensure the achievement of a uniform conveyance of blanks out of a conveyor channel running toward the conveyor spindle on the one hand and ensure that a separation of the blanks can occur along the conveyor path of the conveyor spindle on the other hand. This separation is necessary because only one blank, which can also be called a bowl or cup, can be conveyed into the end position within a very short time window during the excess movement of the shaping machine in order to then be shaped into the can body by the shaping machine.

The drive of the conveyor spindle can occur at a constant rotational speed. The conveyor spindle can be driven by a special electrical drive device, such as a servomotor. Alternatively, it is also possible to embody the drive device of the conveyor spindle as an auxiliary drive of the shaping machine. The conveyor spindle provides for continuous feeding of blanks conveyed from the congestion to the conveyor spindle and into the working position or end position in the shaping machine. Exact positioning of the blanks is guaranteed. Furthermore, appropriate choice of the inclination of the conveyor groove and the rotational speed of the conveyor spindle will optimally exploit the smooth running of the shaping machine.

Preferably, the inclination of the conveyor groove is constant on a front end section as viewed in the conveying direction. The blanks conveyed in congestion in a conveyor channel are seized by the conveyor spindle within this front end section. In the front end section, the diameter of the conveyor spindle can be smaller than that in the subsequent sections in the conveying direction.

It is furthermore advantageous for the inclination of the conveyor groove in a center section joined to the front end section in the conveying direction to be larger than in the front end section. The inclination or pitch of the conveyor groove in the center section consequently increases in relation to the front end section. In the center section it can continuously rise in the conveying direction. The blanks are separated in this center section. Their clearance increases as viewed in the conveying direction. The diameter of the conveyor spindle and/or the depth of the conveyor groove can increase if the inclination or pitch of the conveyor groove rises. The blanks are encompassed within a larger circumferential range due to the increasing depth of the conveyor groove. Since the conveying speed of the blanks increases as the pitch increases, this ensures reliable and damage-free transport of the blanks.

It is furthermore advantageous for the inclination of the conveyor groove in a rear end section joined to the center section to decrease in the conveying direction. After the separating, the conveying speed along the conveyor path can thereby be reduced before the end position is reached. In the preferred embodiment example, the blanks are conveyed out of a conveyor channel along a straight conveyor path and into their end position.

As viewed in the conveying direction, the conveyor groove in a rear end section of the conveyor spindle terminates in a circular circumferential recess running around the longitudinal axis of the conveyor spindle. When a blank reaches the circumferential recess, linear conveying movement is no longer generated even during continuous rotation of the conveyor spindle. The blank remains in this end position. A positioning means adjoining the circumferential recess in the conveying direction can be present to establish this end position precisely. A blank sits in its end position on this positioning means. The positioning means can be an end flange of the conveyor spindle for example or a stop element separate from the conveyor spindle. This stop element preferably has a prismatic stop face.

Changing the pitch or inclination of the conveyor groove accelerates or slows down the transported blanks. In this process, the change in pitch of the conveyor groove is set so that the positive or negative acceleration of the blanks that it causes, as viewed in the conveying direction, does not have a jump discontinuity. The time derivative of the acceleration of the blanks along the linear conveyor path in the conveying direction is therefore continuous. In this manner, a gentle transport of the blanks without jerks therefore takes place.

In one embodiment example, the guide element can be embodied as another, second conveyor spindle. The blanks are then transported into their end position between the two conveyor spindles. The two conveyor spindles each have a conveyor groove. They synchronously rotate in opposite direction to one another. In another embodiment, the guide element can be embodied as a guide rail having an essentially flat guide surface.

Advantageous embodiments of the conveyor device arise from the dependent claims and the description. The description is limited to essential characteristics of the invention and other facts.

### IN THE DRAWINGS

The drawing is to be considered supplementary. The drawing shows: FIGS. 1 through 3 each an embodiment example of the conveyor device in schematic top view along the conveying direction.

FIG. 1 depicts a first embodiment example of conveyor device 10 having conveyor spindle 11.

FIG. 2 shows a second embodiment conveyor device 10. FIG. 2 essentially corresponds to the first embodiment except that stop element 32 is configured separately from conveyor spindle 11 and has a stop face 33.

FIG. 3 shows a third embodiment of conveyor device 10 including a second conveyor spindle identified as supplementary conveyor spindle 35.

### DETAILED DESCRIPTION OF THE INVENTION

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

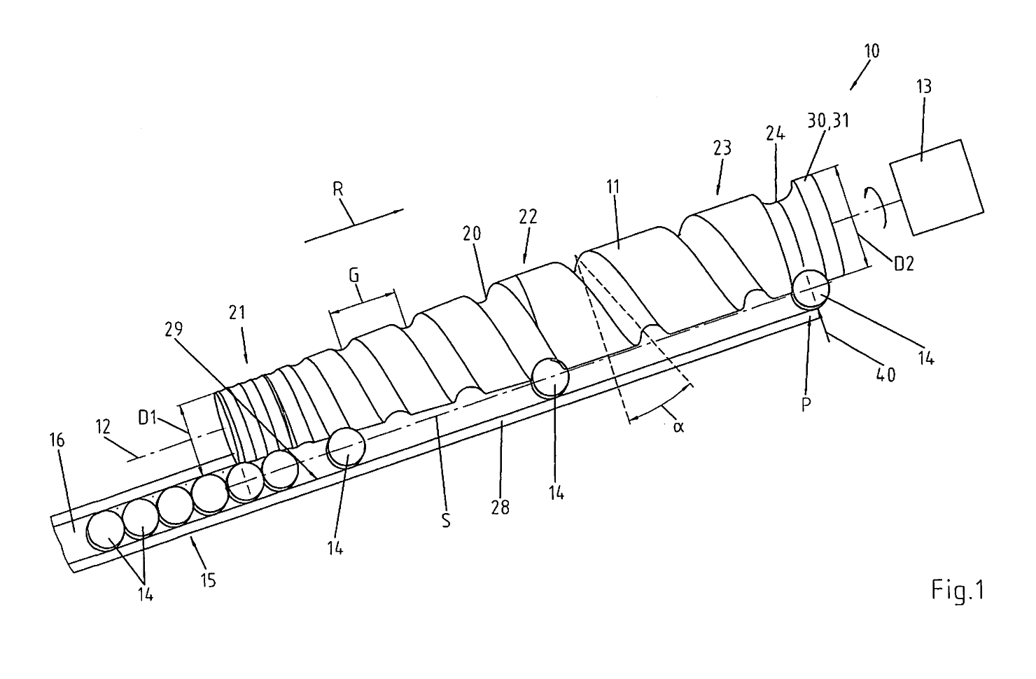

FIG. 1 depicts a first embodiment example of a conveyor device 10 having a conveyor spindle 11. The conveyor spindle 11 is driven around its longitudinal axis 12 preferably with constant rotational speed. A conveyor drive 13 of the conveyor device 10 serves this purpose. The conveyor drive 13 can be embodied as a separate electrical drive of the conveyor device 10 or as an auxiliary drive of a shaping machine, such as a press, not illustrated in detail. In any case, the conveyor drive 13 runs synchronously with the cycle of the shaping machine.

In the first embodiment example, the conveyor device 10 is assigned to a shaping machine for producing can bodies. The conveyor spindle 11 transports bowls 14 from a stowage area 15 into a conveyor channel 16 along a conveyor path S into an end position P. The blank 14 has a pot-like shape and will hereinafter be called a bowl or cup 14. The end position P can also be called a working position. In this end position P, the bowl 14 is located in the shaping machine, which is not illustrated in detail, for further shaping into a can body. In particular, it is positioned flush coaxial to a blank holder or drawing punch of the shaping machine. In this process, the pot opening of the bowl points toward the blank holder or drawing punch.

The conveyor spindle 11 moves the bowls 14 straightly along the conveyor path S into their end position P. For this purpose, the conveyor spindle 11 has a spiral-like conveyor groove 20 which is provided on its exterior surface and is outwardly open. The inclination or pitch G changes along the conveyor path S in the conveying direction R. The conveyor spindle 11 has a front end section 21 which is assigned to the stowage area 15 of the conveyor channel 16. Inside this front end section 21, the pitch G or inclination α of the conveyor groove 20 is constant. The pitch G is essentially adapted to the size of the bowls 14. In this front end section 21, the bowls 14 are transported along the conveyor path S with very small clearance. The clearance between two adjacent conveyed bowls 14 is smaller than the diameter or smaller than the radius of the base of one bowl 14.

The inclination α of the conveyor groove 20 is the angle that encloses the conveyor groove 20 in relation to a plane running perpendicular to the longitudinal axis 12. A center section 22 of the conveyor spindle 11 is joined to the front end section 21 in a conveying direction R. In this center section 22, the inclination α and thereby also the pitch G of the conveyor groove 20 increases in comparison to the inclination α or the pitch G in the front end section 21. In the embodiment example, the diameter D of the conveyor spiral 11 also becomes larger with increasing inclination α or pitch G of the conveyor groove 20. In FIG. 1 it is evident that the diameter D1 in the front end section 21 is smaller than the diameter D2 in the opposite rear end section 23. In the center section 22 located therebetween, the diameter D increases with the inclination α or the pitch G. The groove depth of the conveyor groove 20 also rises with the increase of the diameter D. The groove depth of the conveyor groove 20 is therefore larger for a larger inclination α. The transport speed of the bowl 14 along the linear conveyor path S also rises with increasing inclination α or increasing pitch G of the conveyor groove 20. To prevent damage, the groove depth of the conveyor groove 20 increases with increasing pitch G so that the bowl 14 to be transported rests against the conveyor spindle 11 inside the conveyor groove 20 along a larger circumferential range.

In one embodiment example of the conveyor device 10, the inclination α and thereby also the pitch G of the conveyor groove 20 increases in comparison to the inclination α or the pitch G in the front end section 21 as previously described only in a first subsection of the center section 22 adjacent to the front end section 21. In the further course of the center section 22, the inclination α and thereby also the pitch G of the conveyor groove 20 can then be constant. This second subsection with constant inclination is optional and as a rule is provided for larger conveyor paths.

The rear end section 23 of the conveyor spindle 11 is joined to the center section 22. In this rear end section 23, the conveyor groove 20 flows into a circumferential recess 24. The circumferential recess 24 is incorporated circularly coaxial to the longitudinal axis 12 of the conveyor spindle 11 in its exterior. The pitch G or inclination α of the conveyor groove 20 can be smaller in the rear end section 23 than in the center section 22. The inclination α of the guide groove 23 in the rear end section 23 decreases in the direction of the circumferential recess 24 in order to reduce the transport speed of the bowl 14 along the conveyor path S before reaching the end position P. The change of the inclination α or pitch G can also affect only one portion of a rotation of the spiral of the conveyor groove 20 around the longitudinal axis 12 of the conveyor spindle 11.

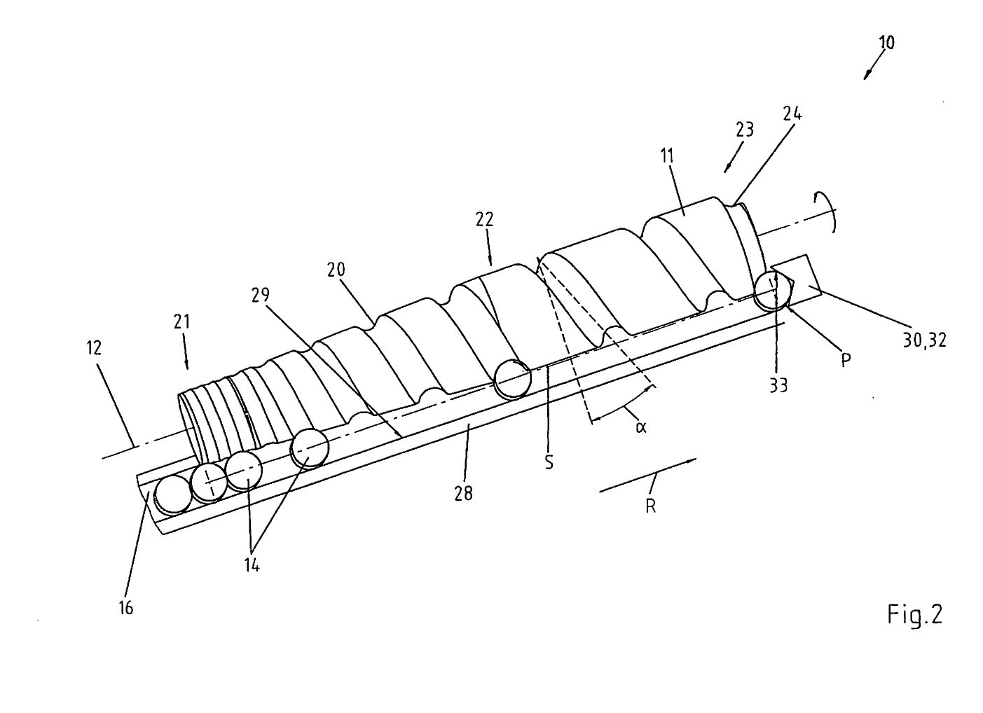

A guide element 28 extends along the conveyor path S separated from the exterior of the conveyor spindle 11 or conveyor groove 20. The guide element 28 is embodied rail-like in the first two embodiment examples of the conveyor device 10 according to FIGS. 1 and 2. It has an essentially flat guide surface 29 which faces the conveyor spindle 11. During the transport of the bowls 14 along the conveyor path S, the bowls 14 rest against a circumferential section on the guide groove 20 of the conveyor spindle 11 and, on their opposite side, rest against the guide surface 29 of the guide element 28. The bowl 14 carries out a relative motion during its transport along the conveyor path S both relative to the conveyor spindle 11 and also relative to the guide element 28. During this relative motion, the bowl 14 can slide along the guide element 28 or roll on it.

The cross-sectional shape of conveyor groove 21 is adapted for example to the cylindrical contour of the pot-like bowls 14. Viewed in cross section, this can have a circular-arc-shaped course, particularly in the region of the largest groove depth, the radius of this course preferably corresponding approximately to that of the bowl 14. But alternatively, the groove 14 can also have any other desired contour so that the conveyor groove 20 is not adapted to the contour of the bowl 14. The bowl can be embodied as a polygon in cross section, particularly a regular polygon, a square for example, or as an oval or in any other shape.

A positioning means 30 is provided adjacent to the circumferential recess 24. The positioning means 30 serves for setting the end position P of a bowl 14 at the end of the conveyor path S. In the first embodiment example of the conveyor device 10 according to FIG. 1, the positioning means 30 is formed by an end flange 31 of the conveyor spindle 11. The end flange 31 borders the circumferential recess 24 in the conveying direction R so that the circumferential recess 24 forms an annular groove arranged coaxial to the longitudinal axis 12.

The first embodiment example of the conveyor device 10 according to FIG. 1 operates as follows:

A number of bowls 14 lined up one after another in a row are situated in the stowage area 15 of the conveyor channel 16. A corresponding inclination of the conveyor channel 16 for example feeds them to the front end section 21 of the of the conveyor spindle 11. The conveyor drive 13 rotates the conveyor spindle 11 around its longitudinal axis 12 with constant rotational speed. The open end of the conveyor groove 20 captures one bowl 14 after another out of the stowage area 15 on the front end section 21. The bowls 14 move along the conveyor path S due to the rotation of the conveyor spindle 11 and the inclination α of the conveyor groove 20. The inclination α of the conveyor groove 20 is constant in the front end section 21. The bowls 14 therefore also move at a constant speed along the conveyor path S.

In the center section 22, the inclination α of the conveyor groove 20 increases in the first subsection adjacent to the front end section, thereby accelerating the bowls 14 and raising the conveying speed. At the same time, the pitch G of the conveyor groove 20 and the clearance between two adjacent conveyed bowls 14 increases. The bowls 14 are separated so to say. In a second subsection of the center section 22 joined thereto, the inclination of the conveyor groove can be constant.

Before reaching the circumferential recess 24 and therefore the end position P, the inclination α of the conveyor groove 20 decreases in the rear end section 23 and the transport speed of the bowls 14 drops. The bowls 14 therefore move gently into the end position P. As soon as the bowls 14 reach the circumferential recess 24, they are in their end position P at the end of the conveyor path S. In this position, they are situated in the position inside a shaping machine in which they are seized by a blank holder or drawing punch of the shaping machine and are shaped.

The changes in inclination of the conveyor groove 20 or the changes in pitch are embodied so that the thereby caused transport movement of the bowls 14 occurs without jerks. This means that the change in acceleration of the bowls 14 along the straight transport path S is continuous. The acceleration of the bowls 14 does not have any jumps. Jump discontinuities in the acceleration of a body are observed as a jerk. The relatively thin-walled bowls 14 could thereby be damaged and bent in particular. This can lead to destruction of the bowl 14 in the subsequent processing by the shaping machine.

FIG. 2 shows a second embodiment example of conveyor device 10. FIG. 2 essentially corresponds to the first embodiment example according to FIG. 1. In contrast to the first embodiment example, the positioning means 30 configured as a stop element 32 which is configured separately from the conveyor spindle 11 and has a stop face 33. In the embodiment example according to FIG. 2, the stop face 33 has a prismatic shape, so that the cylindrical exterior surface of the bowls 14 rests against the stop face 33 in at least two locations and defines the end position P. The stop element 32 is arranged in a straight extension of the conveyor path S.

Another difference of the second embodiment example relative to the first embodiment example consists of the fact that the circumferential recess 24 of the conveyor spindle 11 is open not only radially outwards, but is also open in the conveying direction R. In the second embodiment example, the stop element 32 is provided in place of the end flange 31. In other respects, the second embodiment example according to FIG. 2 corresponds to the first embodiment example according to FIG. 1 in construction and function. To this extent reference is made to the preceding description of the first embodiment example.

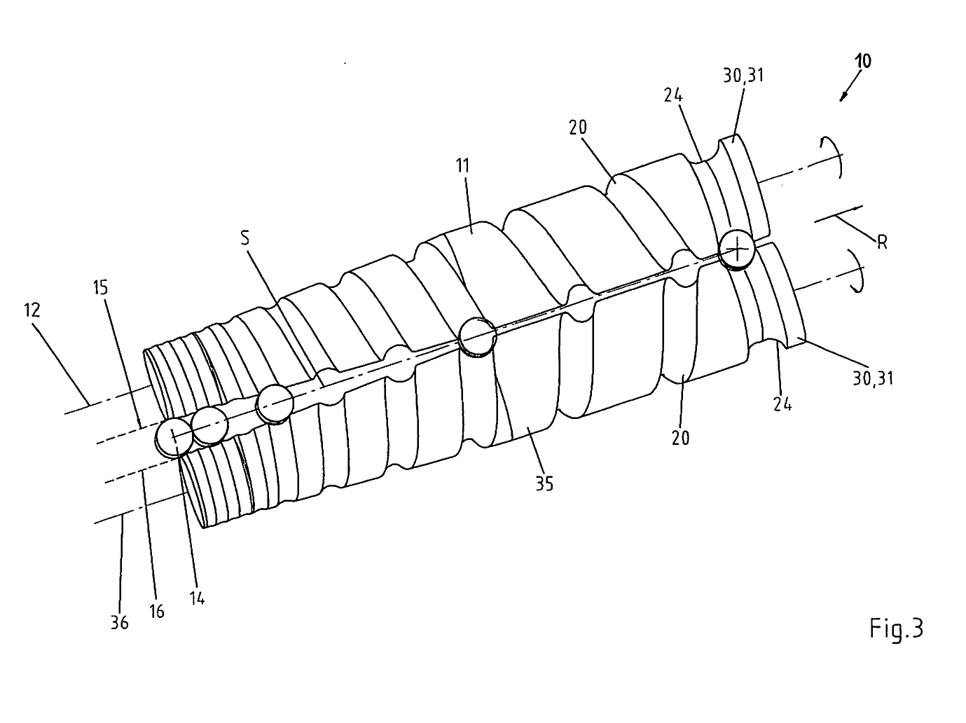

FIG. 3 shows a third embodiment of conveyor device 10. FIG. 3 shows a second conveyor spindle, called a supplementary conveyor spindle 35 for better discriminability, spindle 35 is provided in place of rail-like guide element 28. The conveyor path S runs between the conveyor spindle 11 and the supplementary conveyor spindle 35. The two spindles 11, 35 are synchronously driven in opposite directions. The arrangement is symmetrical along the conveyor path S between the two spindles 11, 35 relative to a center longitudinal plane. The inclination α of the two spindles 11, 35 is therefore opposite but of equal size along the conveyor path S.

Also the clearance and therefore the gap between the two spindles 11, 35 varies depending on the diameter D of the two spindles 11, 35. The longitudinal axis 12 of the conveyor spindle 11 and the longitudinal axis 36 of the supplementary conveyor spindle 35 are aligned parallel to one another. The conveyor spindle 11 corresponds to the conveyor spindle of the first embodiment example according to FIG. 1. The supplementary conveyor spindle 35 is constructed analogously to it, wherein there is provided only an oppositely wound conveyor groove 20. The end position P of the conveyor path S is provided between the two circumferential recesses 24 of the conveyor spindle 11 on one side and the supplementary conveyor spindle 35 on the other side. The conveyor spindle 11 and the supplementary conveyor spindle 35 can each be driven around their respective longitudinal axis 12 or 36 by separate drive devices or by a common drive device. Here too, the drive device can be embodied as an auxiliary unit of the shaping machine as explained in connection with the first embodiment example.

In the third embodiment example, it is understood that a stop element 32 could be arranged as positioning means 30 at the end of the conveyor path S in place of the end flange 31 of the conveyor spindle 11 and the supplementary conveyor spindle 31. The end flange 31 is nevertheless preferred for reasons of space.

In all embodiment examples, the drive device 13 of the conveyor spindle 11 or of the supplementary conveyor spindle 35 can also simultaneously serve for actuating a holding means 14, which in FIG. 1 is schematically indicated only in the form of an arrow. The holding means 40 can be used to keep the bowl 14, which is in its end position P, from prematurely falling into a mold of the shaping machine. The holding means 40 releases the bowl 14, which is in the end position P, only at a defined time when the plunger of the shaping machine is supposed to shape the bowl 14. For sake of example, a movable disc or the like can serve as holding means 40.

The invention relates to a conveyor device 10 for conveyance of bowls 14 from a stowage area 15 into a predetermined end position P. In this end position P, the bowl 14 is positioned so that it can be shaped into a can body by the stroke of the plunger of the shaping machine. The conveyor device 10 has a conveyor spindle 11 which has a conveyor groove 20 on its external circumference. On the front end area 21 assigned to the stowage area 15, the inclination α and the pitch G of the conveyor groove 20 are constant. The front end section 21 is joined to a section 22 in which the inclination α of the conveyor groove 20 is larger than in front end area 21. The conveyor spindle 11 is preferably driven at constant rotational speed and ensures that the bowls 14 are transported in a straight line along the conveyor path S. In the process, the conveyor spindle 11 slides along the bowl 14 to be transported.

### List of Reference Characters

10 conveyor device
11 conveyor spindle
12 longitudinal axis of 11
13 conveyor drive
14 bowl
15 stowage area
16 conveyor channel
20 conveyor groove
21 front end section
22 center end section
23 rear end section
24 circumferential recess
28 guide element
29 guide flange
30 positioning means
31 end flange
32 stop element
33 stop face
35 supplementary conveyor spindle
36 longitudinal axis of 35
40 holding means
α inclination
G pitch
P end position
R conveying direction
S conveyor path

1. Conveyor device for conveyance of blanks (14),
having a drivable conveyor spindle (11), which has a spiral-like conveyor groove (20) on its exterior,
having a guide element (28), which is arranged separated from the longitudinal axis (12) of the conveyor spindle (11) and extends along the conveyor spindle (11),
wherein the inclination (α) of the conveyor groove (20) changes in the conveying direction (R) of the conveyor spindle (11).

2. Conveyor device according to claim 1,
characterized in that the inclination (α) of the conveyor groove (20) is constant on a front end section (21) of the conveyor spindle (11) as viewed in the conveying direction (R).

3. Conveyor device according to claim 2,
characterized in that the inclination (α) of the conveyor groove (20) in a center section (22) joined to the front end section (21) in the conveying direction (R) is larger than in front end section (21).

4. Conveyor device according to claim 3,
characterized in that the inclination (α) of the conveyor groove (20) in the center section (22) increases in the conveying direction (R).

5. Conveyor device according to claim 1,
characterized in that the inclination (α) of the conveyor groove (20) in a rear end section (23) joined to the center section (22) in the conveying direction (R) decreases in the conveying direction (R).

6. Conveyor device according to claim 1,
characterized in that the conveyor groove (20) in a rear end section (23) joined to the center section (22) in the conveying direction (R) flows into a circular circumferential recess (24) running around the longitudinal axis (12) of the conveyor spindle (11).

7. Conveyor device according to claim 6,
characterized in that a positioning means (30) adjoining the circumferential recess (24) in the conveying direction (R) is present for positioning the conveyed blank (14) into an end position (P).

8. Conveyor device according to claim 7,
characterized in that the positioning means (30) has an end flange (31) of the conveyor spindle (11) or a stop element (32) arranged next to the conveyor spindle (11).

9. Conveyor device according to claim 1,
characterized in that the change in inclination is embodied in such a manner that a thereby caused acceleration of the blanks (14) in the conveying direction (R) does not exhibit any jump discontinuity.

10. Conveyor device according to claim 1,
characterized in that the guide element (28) is embodied as another supplementary conveyor spindle (35).
